(19) United States
(12) Patent Application Publication
(10) Pub. No.: US 2026/0051758 A1
(43) Pub. Date: Feb. 19, 2026

(54) APPARATUS AND METHOD FOR MANAGING CHARGING STATUS OF BATTERY

(71) Applicant: SAMSUNG SDI CO., LTD., Yongin-si (KR)

(72) Inventor: Young Shin CHO, Yongin-si (KR)

(21) Appl. No.: 19/295,051

(22) Filed: Aug. 8, 2025

(30) Foreign Application Priority Data
Aug. 14, 2024 (KR) 10-2024-0109436

(51) Int. Cl. H02J 7/00

(52) U.S. Cl. CPC H02J 7/0071; H02J 7/0047

(57) ABSTRACT

An apparatus for managing a charging status of a battery includes: a battery usage history collection unit configured to collect a user's battery usage time information and battery usage history for a reference period of time; a battery usage pattern analysis unit configured to analyze a user's battery usage pattern according to a time zone based on the user's battery usage time information and the battery usage history; and a charging control unit configured to control charging of the battery by setting an auxiliary charging mode of the battery according to the user's battery usage pattern and the time zone.

### CROSS-REFERENCE TO RELATED APPLICATION

The present application claims priority to and the benefit of Korean Patent Application No. 10-2024-0109436, filed on Aug. 14, 2024, in the Korean Intellectual Property Office, the entire disclosure of which is incorporated herein by reference.

### BACKGROUND

### 1. Field

Aspects of embodiments of the present disclosure relate to an apparatus and a method for managing a charging status of a battery.

### 2. Description of the Related Art

Different from primary batteries, which are not designed to be charged, secondary batteries are designed to be discharged and recharged. Low-capacity secondary batteries are used in small, portable electronic devices, such as smart phones, feature phones, notebook computers, digital cameras, and camcorders, while large-capacity secondary batteries are widely used as power sources for driving motors, such as of hybrid vehicles or electric vehicles, and for power storage. A secondary battery generally includes an electrode assembly including (or consisting of) a positive electrode and a negative electrode, a case that accommodates the electrode assembly, a terminal part connected to the electrode assembly.

When a standby current continues to occur (e.g., is continuously applied to a battery) after charging of a battery is completed, a situation occurs where auxiliary charging (or recharging) is repeated to compensate for a lowered state of charge (SOC). In this case, deterioration of the battery accelerates, which rapidly shortens the battery life, and in the case of a cylindrical battery, a current interrupt device (CID) may open due to accumulated gas pressure, which may cause a safety accident.

The above information disclosed in this Background section is for enhancement of understanding of the background of the present disclosure, and therefore, it may contain information that does not constitute the related (or prior) art.

### SUMMARY

Embodiments of the present disclosure provide an apparatus and a method for managing a charging status of a battery, which set an auxiliary charging mode of a battery according to a battery usage pattern according to a time zone based on battery usage time information and battery usage history of a user.

However, aspects and features of the present disclosure are not limited those mentioned above, and other aspects and features not mentioned herein will be clearly understood by those skilled in the art from the description of the present disclosure below.

An apparatus for managing a charging status of a battery, according to an embodiment of the present disclosure, includes: a battery usage history collection unit configured to collect a user's battery usage time information and battery usage history for a reference period of time; a battery usage pattern analysis unit configured to analyze a user's battery usage pattern according to a time zone based on the user's battery usage time information and the battery usage history; and a charging control unit configured to control charging of the battery by setting an auxiliary charging mode of the battery according to the user's battery usage pattern and the time zone.

The battery usage pattern analysis unit may be configured to classify the time zone into a battery usage time zone and a battery non-use time zone, and may analyze the user's battery usage pattern.

The battery usage pattern analysis unit may be configured to receive the user's battery usage time information and the battery usage history, learn the user's battery usage pattern according to the time zone, classify the time zone into the battery usage time zone and the battery non-use time zone, and analyze the user's battery usage pattern.

The battery usage pattern analysis unit may be configured to divide the reference period of time into sections to form a histogram and to accumulate a charge/discharge frequency.

The battery usage pattern analysis unit may be configured to set, as the battery usage time zone, one or more sections in which the charge/discharge frequency is equal to or greater than a reference number of times in a histogram pattern, and to set, as the battery non-use time zone, one or more sections in which the charge/discharge frequency is less than the reference number of times in the histogram pattern.

The battery usage pattern analysis unit may be configured to periodically update the histogram.

The reference period of time may be 24 hours and the sections may each be one hour.

The reference period of time may be 7 days and the sections may each be one day.

When a current time after the charging of the battery is completed is in the battery non-use time zone, the charging control unit may be configured to change the auxiliary charging mode to a long-life auxiliary charging mode in which a stress index of the battery is lowered.

When an expected completion time of the charging of the battery while charging the battery is in the battery non-use time zone, the charging control unit may be configured to change the auxiliary charging mode to a long-life auxiliary charging mode in which a stress index of the battery is lowered.

A method for managing a charging status of a battery, according to an embodiment of the present disclosure, includes: collecting a user's battery usage time information and battery usage history for a reference period of time; analyzing the user's battery usage pattern according to a time zone based on the user's battery usage time information and the battery usage history; and controlling charging of the battery by setting an auxiliary charging mode of the battery according to the user's usage pattern and the time zone.

The collecting of the user's battery usage time information and battery usage history may include classifying the time zone into a battery usage time zone and a battery non-use time zone, and analyzing the user's battery usage pattern.

The analyzing of the user's battery usage pattern may include receiving the user's battery usage time information and the battery usage history, learning the user's battery usage pattern according to the time zone, classifying the time zone into the battery usage time zone and the battery non-use time zone, and analyzing the user's battery usage pattern.

The analyzing of the user's battery usage pattern may include dividing the reference period of time into sections to form a histogram, and accumulating a charge/discharge frequency.

The analyzing of the user's battery usage pattern may include setting, as the battery usage time zone, one or more sections in which the charge/discharge frequency is equal to or greater than a reference number of times in a histogram pattern, and setting, as the battery non-use time zone, one or more sections in which the charge/discharge frequency is less than the reference number of times in the histogram pattern.

The analyzing of the user's battery usage pattern may include periodically updating the histogram.

The reference period of time may be 24 hours and the sections may each be one hour.

The reference period of time may be 7 days and the sections may each be one day.

The controlling the charging of the battery may include, when a current time after the charging of the battery is completed is in the battery non-use time zone, changing the auxiliary charging mode to a long-life auxiliary charging mode in which a stress index of the battery is lowered.

The controlling charging of the battery may include, when an expected completion time of the charging of the battery while charging the battery is in the battery non-use time zone, changing the auxiliary charging mode to a long-life auxiliary charging mode in which a stress index of the battery is lowered.

A user device according to an embodiment of the present disclosure may include the apparatus for managing a charging status of a battery.

According to embodiments of the present disclosure, by setting an auxiliary charging mode of a battery according to a battery usage pattern and a time zone based on a user's battery usage time information and battery usage history, unnecessary auxiliary charging can be reduced and the battery life can be improved.

According to embodiments of the present disclosure, an auxiliary charging mode is optimally set according to a user's battery usage pattern according to a time zone based on the user's battery usage time information and battery usage history, thereby improving the battery life while providing the user with an optimal battery capacity.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to the specification illustrate embodiments of the present disclosure and further describe aspects and features of the present disclosure together with the detailed description of the present disclosure. Thus, the present disclosure should not be construed as being limited to the drawings, in which:

FIG. 1 is a schematic diagram illustrating an apparatus for managing a charging status of a battery according to an embodiment of the present disclosure;

FIG. 2 is a graph describing a method for expanding an auxiliary charging interval in a long-life auxiliary charging mode that can be set by a charging control unit of the apparatus for managing a charging status of a battery according to an embodiment of the present disclosure;

FIG. 3 is a graph describing a method for moving the auxiliary charging interval in the long-life auxiliary charging mode that can be set by the charging control unit of the apparatus for managing a charging status of a battery according to an embodiment of the present disclosure;

FIG. 4 is a diagram describing a battery usage pattern applicable to the apparatus for managing a charging status of a battery according to an embodiment of the present disclosure in a daily schedule;

FIG. 5 is a diagram illustrating an example in which a battery usage pattern analysis unit of the apparatus for managing a charging status of a battery according to an embodiment of the present disclosure analyzes a battery usage pattern of a user;

FIG. 6 is a diagram illustrating an example in which the battery usage pattern analysis unit of the apparatus for managing a charging status of a battery according to an embodiment of the present disclosure analyzes a battery usage pattern of a user by using a histogram; and

FIG. 7 is a flowchart describing steps of a method for managing a charging status of a battery according to an embodiment of the present disclosure.

### DETAILED DESCRIPTION

Embodiments of the present disclosure will be described below, in detail, with reference to the accompanying drawings. Prior to the description, it is noted that the terms or words used in this specification and claims should not be construed as being limited to their common or dictionary meanings but instead should be understood to have meanings and concepts consistent with the spirit of the present disclosure based on the principle that an inventor can define the concept of each term suitably in order to describe his/her own invention in the best way possible. Also, because the embodiments described in this specification and the configurations illustrated in the drawings are only example embodiments of the present disclosure, they do not cover all the technical ideas of the present disclosure, and it should be understood that various changes and modifications may be made at the time of filing this application.

It will be further understood that the terms “comprises/includes” and/or “comprising/including” when used herein, specify the presence of stated features, integers, steps, operations, elements, components, and/or groups thereof but do not preclude the presence or addition of one or more other features, integers, steps, operations, elements, components, and/or groups thereof.

To facilitate understanding of the present disclosure, the accompanying drawings may not be drawn to scale and the dimensions of some components may be exaggerated. It should be noted that the same reference numerals are designated to the same components in different embodiments.

Reference to two compared elements, features, etc. as being “the same” means that they are “substantially the same”. Therefore, the phrase “substantially the same” may include a deviation that is considered low in the art, for example, a deviation of about 5% or less. The uniformity of any parameter in a given region may mean that it is uniform from an average perspective.

Although the terms such as “first” and/or “second” are used to describe various components, these components are not limited by these terms. These terms are only used to distinguish one component from another component. Thus, unless specifically stated to the contrary, a first component may be termed a second component without departing from the teachings of exemplary embodiments.

Throughout the specification, unless otherwise stated, each element may be singular or plural.

Arrangement of any component “above (or below)” or “on (or under)” a component may mean that any component is disposed in contact with the upper (or lower) surface of the component, as well as that other components may be interposed between the element and any element disposed on (or under) the element.

It will be understood that, when a component is referred to as being “connected”, “coupled”, or “joined” to another component, not only can it be directly “connected”, “coupled”, or “joined” to the other element, but also can it be indirectly “connected”, “coupled”, or “joined” to the other element with other elements interposed therebetween.

As used herein, the term “and/or” includes any and all combinations of one or more of the associate listed items. The use of “may” when describing embodiments of the present disclosure relates to “one or more embodiments of the present disclosure”. Expressions, such as “at least one” and “one or more,” preceding a list of elements modify the entire list of elements and do not modify the individual elements in the list.

Throughout the specification, when “A and/or B” is stated, it means A, B, or A and B, unless otherwise stated. In addition, when “C to D” is stated, it means C or more and D or less, unless specifically stated to the contrary.

When the phrase such as “at least one of A, B, and C”, “at least one of A, B, or C”, “at least one selected from the group of A, B, and C”, or “at least one selected from among A, B, and C” is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Accordingly, a first element, component, region, layer, or section discussed below may be termed a second element, component, region, layer, or section without departing from the teachings of exemplary embodiments.

For ease of explanation in describing the relationship of one element or feature to another element(s) or feature(s) as illustrated in the drawings, spatially relative terms such as “beneath”, “below”, “lower”, “above”, and “upper” may be used herein. It will be understood that spatially relative positions are intended to encompass different directions of the device in use or operation in addition to the direction depicted in the drawings. For example, if the device in the drawings is turned over, any element described as being “below” or “beneath” another element would then be oriented “above” or “over” another element. Therefore, the term “below” may encompass both upward and downward directions.

The terminology used herein is for the purpose of describing embodiments of the present disclosure and is not intended to limit the present disclosure.

The battery usage history collection unit, battery usage pattern analysis unit, charging control unit, and/or any other relevant devices or components according to embodiments of the present disclosure described herein may be implemented utilizing any suitable hardware, firmware (e.g., an application-specific integrated circuit), software, and/or a suitable combination of software, firmware, and hardware. For example, the various components of the battery usage history collection unit, battery usage pattern analysis unit, and/or charging control unit may be formed on one integrated circuit (IC) chip or on separate IC chips. Further, the various components of the battery usage history collection unit, battery usage pattern analysis unit, and/or charging control unit may be implemented on a flexible printed circuit film, a tape carrier package (TCP), a printed circuit board (PCB), or formed on a same substrate as the battery usage history collection unit, battery usage pattern analysis unit, and/or charging control unit. Further, the various components of the battery usage history collection unit, battery usage pattern analysis unit, and/or charging control unit may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device or the functionality of a particular computing device may be distributed across one or more other computing devices without departing from the scope of the exemplary embodiments of the present disclosure.

Embodiments of the present disclosure will be described, in detail, with reference to the attached drawings.

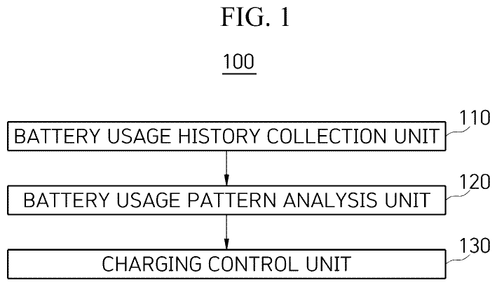

FIG. 1 is a diagram schematically illustrating an apparatus 100 for managing a charging status of a battery according to an embodiment of the present disclosure.

Referring to FIG. 1, the apparatus 100 for managing a charging status of a battery according to an embodiment of the present disclosure may include a battery usage history collection unit 110, a battery usage pattern analysis unit 120, and a charging control unit 130.

A battery having its charging status managed by the apparatus 100 for managing a charging status of a battery according to an embodiment of the present disclosure is a battery cell configured to be charged and discharged (e.g., a secondary battery), in which an electrode assembly including a positive electrode/a separator/a negative electrode structure is sealed inside a battery case while being impregnated with a lithium electrolyte. An electrode assembly generally has a jelly-roll structure (a so-called winding type electrode assembly) in which long sheet-shaped positive electrode and negative electrode with active materials applied on both surfaces thereof are wound (or rolled) into a round shape with a separator interposed therebetween, and a stacked (or laminated) structure (a so-called stacked type electrode assembly) in which a plurality of positive electrodes and negative electrodes having a certain (e.g., predetermined) size with active materials applied on both surfaces thereof are sequentially stacked with a separator interposed therebetween.

The battery, as referenced herein, may include all types of cylindrical and prismatic batteries in which an electrode assembly is accommodated in a battery case, such as a metal can, and pouch-type battery cells, in which an electrode assembly is accommodated in a battery case including (or formed of) an aluminum laminate sheet. In addition, the battery may have a structure (or configuration) in which two or more battery cells are connected in series and/or in parallel.

In an embodiment, a user device may include the apparatus for managing a charging status of a battery according to an embodiment of the present disclosure. In an embodiment, the user device may be an IT (Information Technology) device, an xEV (Electric Vehicle), an ESS (Energy Storage System), or the like.

The battery usage history collection unit 110 collects battery usage time information and battery usage history of a user for a period of time (e.g., a reference or predetermined period of time). In an embodiment, the battery usage history collection unit 110 may collect battery usage history by recording state of charge (SOC) or voltage, which changes as the battery is charged and discharged, according to the battery usage time information for a period of time during which a user uses the battery. The period of time may be set as a period of time during which a certain pattern may be formed (or monitored) when a user uses the battery. For example, the period of time may be set to 24 hours or 7 days.

The battery usage pattern analysis unit 120 may analyze the battery usage pattern of the user according to the time zone based on the battery usage time information and battery usage history of the user. Examples in which the battery usage pattern analysis unit 120 analyzes the battery usage pattern of the user are described below with reference to other drawings.

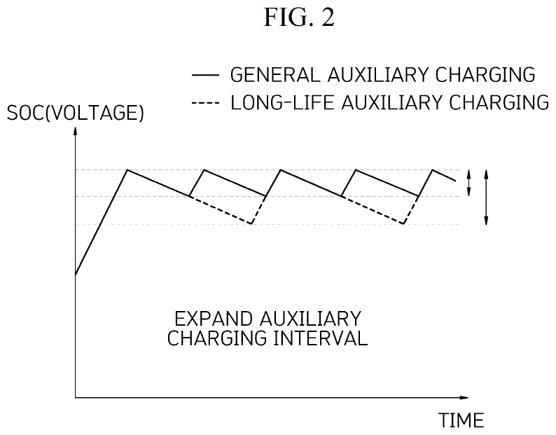

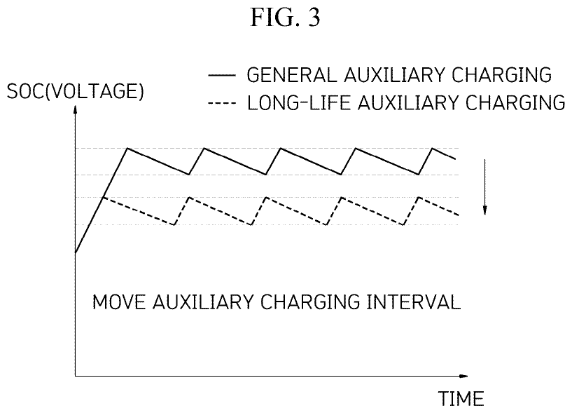

The charging control unit 130 controls the charging of the battery by setting an auxiliary charging mode of the battery according to the usage pattern of the user according to the time zone. Examples in which the charging control unit 130 sets the auxiliary charging mode of the battery are described below with reference to FIGS. 2 and 3.

FIG. 2 is a graph describing a method for expanding an auxiliary charging interval in a long-life auxiliary charging mode that can be set by the charging control unit of the apparatus for managing a charging status of a battery according to an embodiment of the present disclosure, and FIG. 3 is a graph describing a method for 1 moving the auxiliary charging interval in the long-life auxiliary charging mode that can be set by the charging control unit of the apparatus for managing a charging status of a battery according to an embodiment of the present disclosure.

Referring to FIGS. 2 and 3, the charging control unit 130 may change the auxiliary charging mode of the battery to one or more long-life auxiliary charging modes. FIGS. 2 and 3 illustrate example long-life auxiliary charging modes that may be set by the charging control unit 130. FIG. 2 illustrates a method for increasing the auxiliary charging cycle of the battery by expanding the auxiliary charging interval of the battery, and FIG. 3 illustrates a method for moving the auxiliary charging interval of the battery to a lower (e.g., a relatively low) SOC. According to these methods, the number of times the auxiliary charging is repeated may be reduced, and the average of an auxiliary charging voltage and a sustaining voltage is lowered, thereby reducing the stress index of the battery.

However, when such long-life auxiliary charging modes are applied (e.g., singularly or concurrently applied) without considering the usage pattern of a user, a maximum battery capacity provided to the user is reduced, which may result in the user not being able to use the battery for a long time.

Accordingly, the apparatus 100 for managing a charging status of a battery according to an embodiment of the present disclosure optimally sets an auxiliary charging mode according to a battery usage pattern according to a time zone based on battery usage time information and battery usage history of a user, thereby improving the battery life while providing a user with an optimal battery capacity compared to a method for simultaneously adjusting an auxiliary charging interval.

Examples in which the battery usage pattern analysis unit 120 analyzes the battery usage pattern of a user according to the time zone based on the battery usage time information and battery usage history of the user and the charging control unit 130 sets the auxiliary charging mode are described below with reference to the following drawings.

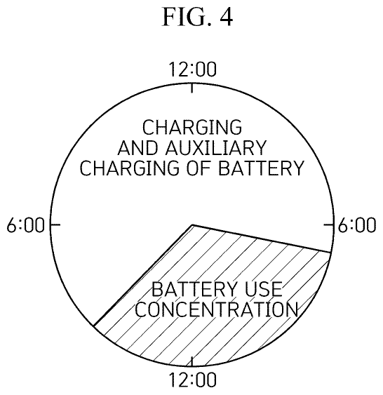

FIG. 4 is a diagram illustrating a battery usage pattern applicable to the apparatus for managing a charging status of a battery according to an embodiment of the present disclosure in a daily schedule.

Referring to FIG. 4, the time zone may be classified into a time zone where a user concentrates on using (e.g., primarily uses) the battery and a time zone where the user hardly uses the battery and charges and auxiliary charges the battery. The battery usage pattern analysis unit 120 learns and defines such time zones. The battery usage pattern analysis unit 120 may classify the time zone into a battery usage time zone and a battery non-use time zone of a user according to the learned result and analyze the battery usage pattern of the user. Subsequently, the charging control unit 130 may set different charging modes according to the time zones.

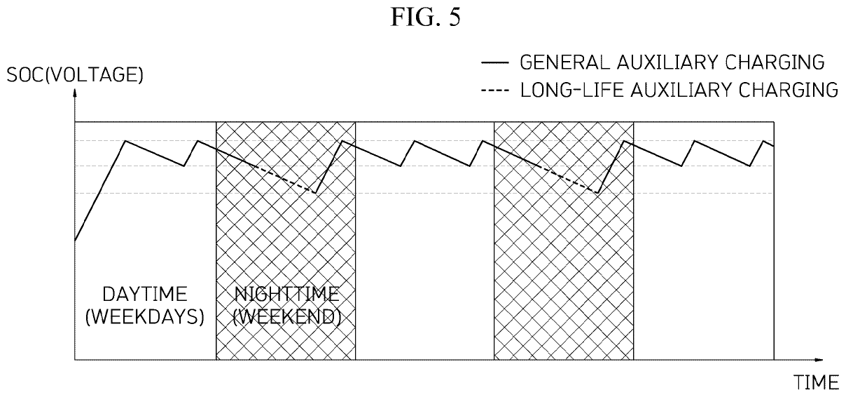

FIG. 5 is a diagram describing an example in which the battery usage pattern analysis unit of the apparatus for managing a charging status of a battery according to an embodiment of the present disclosure analyzes a user's battery usage pattern.

Referring to FIG. 5, the battery usage pattern analysis unit 120 may receive the battery usage time information and the battery usage history of the user, learn the battery usage pattern of the user according to the time zone, classify the time zone into the battery usage time zone and the battery non-use time zone of the user, and analyze the battery usage pattern of the user. FIG. 5 illustrates the results of classifying the battery usage time zone and the battery non-use time zone of the user into daytime and nighttime or weekdays and weekend as the battery usage pattern according to the time zone, and learning and analyzing the time zones. As illustrated in FIG. 5, the charging control unit 130 may control charging by setting a general auxiliary charging mode in which frequent auxiliary charging occurs during daytime or weekdays when the user frequently uses the battery and setting a long-life auxiliary charging mode in which an auxiliary charging cycle is increased during nighttime or weekend when the user hardly uses the battery.

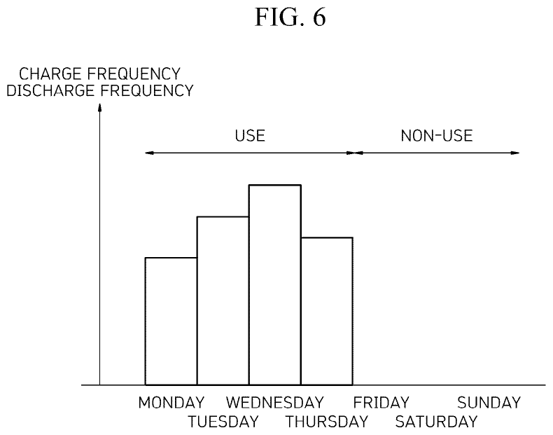

FIG. 6 is a diagram describing an example in which the battery usage pattern analysis unit of the apparatus for managing a charging status of a battery according to an embodiment of the present disclosure analyzes the battery usage pattern of the user by using a histogram.

Referring to FIG. 6, the battery usage pattern analysis unit 120 may set, as the battery usage time zone, one or more sections in which the charge/discharge frequency is equal to or greater than a reference (or predetermined) number of times in a histogram pattern and set, as the battery non-use time zone, one or more sections in which the charge/discharge frequency is less than the reference number of times in the histogram pattern. In an embodiment, the battery usage pattern analysis unit 120 may configure 24 hours as a histogram with 24 sections and accumulate the charge/discharge frequency. In such an embodiment, the reference period of time is 24 hours and a reference (or predefined) section is one hour. In another embodiment, the battery usage pattern analysis unit 120 may configure a histogram with 7 sections for each day of the week and accumulate the charge/discharge frequency. In such a case, the reference period of time is 7 days and the reference section is one day. The battery usage pattern analysis unit 120 may periodically update the histogram to reflect recent (e.g., 2 weeks, 4 weeks, and the like) information.

In an embodiment, when the current time after the charging of the battery is completed is (or occurs in) the battery non-use time zone, the charging control unit 130 may change the auxiliary charging mode to a long-life auxiliary charging mode in which the stress index of the battery is lowered. Alternatively, even before the charging of the battery is completed, when the expected completion time of the charging of the battery while charging the battery is (or is expected to occur in) the battery non-use time zone, the charging control unit 130 may change the auxiliary charging mode to a long-life auxiliary charging mode in which the stress index of the battery is lowered. This is because, even in the battery usage time zone, the charge/discharge frequency may tend to decrease as the battery non-use time zone approaches, so when the expected completion time of charging corresponds to the battery non-use time zone, changing the auxiliary charging mode to the long-life auxiliary charging mode in advance may be more effective in improving the battery life.

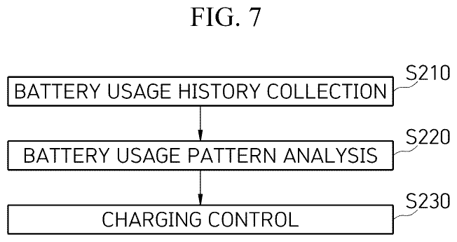

FIG. 7 is a flowchart describing steps of a method for managing a charging status of a battery according to an embodiment of the present disclosure.

As illustrated in FIG. 7, the method for managing a charging status of a battery according to an embodiment of the present disclosure may include steps S210, S220, and S230.

Step S210 is a battery usage history collection step of collecting battery usage time information and battery usage history of a user for a reference (or predetermined) period of time.

Step S220 is a battery usage pattern analysis step of analyzing a battery usage pattern of the user according to a time zone based on the battery usage time information and the battery usage history of the user. In an embodiment, step S220 may include a step of classifying the time zone into a battery usage time zone and a battery non-use time zone of the user and analyzing the battery usage pattern of the user. In another embodiment, step S220 may include a step of receiving the battery usage time information and the battery usage history of the user, learning the battery usage pattern of the user according to the time zone, classifying the time zone into the battery usage time zone and the battery non-use time zone of the user, and analyzing the battery usage pattern of the user.

Step S230 is a charging control step of controlling charging of the battery by setting an auxiliary charging mode of the battery according to the usage pattern of the user according to the time zone. In an embodiment, step S230 may include a step of changing the auxiliary charging mode to a long-life auxiliary charging mode in which a stress index of the battery is lowered when the current time after the charging of the battery is completed is (or occurs in) the battery non-use time zone. In another embodiment, step S230 may include a step of changing the auxiliary charging mode to a long-life auxiliary charging mode in which the stress index of the battery is lowered when the expected completion time of the charging of the battery while charging the battery is (or occurs in) the battery non-use time zone.

A method for managing a charging status of a battery according to embodiments of the present disclosure has been described above with reference to the flow chart presented in the drawings. For simplicity, the method has been illustrated and described as a series of blocks, but the present disclosure is not limited to the order of the blocks, and some blocks may occur in a different order or may occur concurrently (or simultaneously) with other blocks illustrated and described in the present specification, and various other branches, flow paths, and orders of blocks that achieve the same or similar results may be implemented. In addition, all the illustrated blocks may not be required for implementing the method described in the present specification.

In the description with reference to FIG. 7, each step may be further divided into additional steps or combined into fewer steps, depending on the implementation example of the present disclosure. In addition, some steps may be omitted, and the order between the steps may be changed. In addition, even in the case of other omitted content, the content of FIGS. 1 to 6 may be applied to the content of FIG. 7. In addition, the content of FIG. 7 may be applied to the content of FIGS. 1 to 6.

Although the present disclosure has been described above in connection with example embodiments and drawings, the present disclosure is not limited to the embodiments. A person having ordinary knowledge in the art to which the present disclosure pertains may modify and change the present disclosure within the technical spirit of the present disclosure and the equivalent range of the following claims.

What is claimed is:

1. An apparatus for managing a charging status of a battery, the apparatus comprising:
a battery usage history collection unit configured to collect a user's battery usage time information and battery usage history for a reference period of time;
a battery usage pattern analysis unit configured to analyze a user's battery usage pattern according to a time zone based on the user's battery usage time information and the battery usage history; and
a charging control unit configured to control charging of the battery by setting an auxiliary charging mode of the battery according to the user's battery usage pattern and the time zone.

2. The apparatus as claimed in claim 1, wherein the battery usage pattern analysis unit is configured to classify the time zone into a battery usage time zone and a battery non-use time zone, and analyzes the user's battery usage pattern.

3. The apparatus as claimed in claim 2, wherein the battery usage pattern analysis unit is configured to receive the user's battery usage time information and the battery usage history, learns the user's battery usage pattern according to the time zone, classifies the time zone into the battery usage time zone and the battery non-use time zone, and analyzes the user's battery usage pattern.

4. The apparatus as claimed in claim 2, wherein the battery usage pattern analysis unit is configured to divide the reference period of time into sections to form a histogram and to accumulate a charge/discharge frequency.

5. The apparatus as claimed in claim 4, wherein the battery usage pattern analysis unit is configured to set, as the battery usage time zone, one or more sections in which the charge/discharge frequency is equal to or greater than a reference number of times in a histogram pattern, and to set, as the battery non-use time zone, one or more sections in which the charge/discharge frequency is less than the reference number of times in the histogram pattern.

6. The apparatus as claimed in claim 4, wherein the battery usage pattern analysis unit is configured to periodically update the histogram.

7. The apparatus as claimed in claim 4, wherein the reference period of time is 24 hours and the sections are each one hour.

8. The apparatus as claimed in claim 4, wherein the reference period of time is 7 days and the sections are each one day.

9. The apparatus as claimed in claim 2, wherein, when a current time after the charging of the battery is completed is in the battery non-use time zone, the charging control unit is configured to change the auxiliary charging mode to a long-life auxiliary charging mode in which a stress index of the battery is lowered.

10. The apparatus as claimed in claim 2, wherein, when an expected completion time of the charging of the battery while charging the battery is in the battery non-use time zone, the charging control unit is configured to change the auxiliary charging mode to a long-life auxiliary charging mode in which a stress index of the battery is lowered.

11. A method for managing a charging status of a battery, the method comprising:
collecting a user's battery usage time information and battery usage history for a reference period of time;
analyzing the user's battery usage pattern according to a time zone based on the user's battery usage time information and the battery usage history; and
controlling charging of the battery by setting an auxiliary charging mode of the battery according to the user's usage pattern and the time zone.

12. The method as claimed in claim 11, wherein the collecting of the user's battery usage time information and battery usage history comprises classifying the time zone into a battery usage time zone and a battery non-use time zone, and analyzing the user's battery usage pattern.

13. The method as claimed in claim 12, wherein the analyzing of the user's battery usage pattern comprises receiving the user's battery usage time information and the battery usage history, learning the user's battery usage pattern according to the time zone, classifying the time zone into the battery usage time zone and the battery non-use time zone, and analyzing the user's battery usage pattern.

14. The method as claimed in claim 12, wherein the analyzing of the user's battery usage pattern comprises:
dividing the reference period of time into sections to form a histogram, and accumulating a charge/discharge frequency; and
setting, as the battery usage time zone, one or more sections in which the charge/discharge frequency is equal to or greater than a reference number of times in a histogram pattern, and setting, as the battery non-use time zone, one or more sections in which the charge/discharge frequency is less than the reference number of times in the histogram pattern.

15. The method as claimed in claim 14, wherein the analyzing of the user's battery usage pattern comprises periodically updating the histogram.

16. The method as claimed in claim 14, wherein the reference period of time is 24 hours and the sections are each one hour.

17. The method as claimed in claim 14, wherein the reference period of time is 7 days and the sections are each one day.

18. The method as claimed in claim 12, wherein the controlling the charging of the battery comprises, when a current time after the charging of the battery is completed is in the battery non-use time zone, changing the auxiliary charging mode to a long-life auxiliary charging mode in which a stress index of the battery is lowered.

19. The method as claimed in claim 12, wherein the controlling charging of the battery comprises, when an expected completion time of the charging of the battery while charging the battery is in the battery non-use time zone, changing the auxiliary charging mode to a long-life auxiliary charging mode in which a stress index of the battery is lowered.

20. A user device comprising the apparatus for managing a charging status of a battery as claimed in claim 1.
